(19) United States
(12) Patent Application Publication
(10) Pub. No.: US 2016/0086122 A1
(43) Pub. Date: Mar. 24, 2016

(54) SYSTEM AND METHOD FOR PROVIDING MULTI OBJECTIVE MULTI CRITERIA VENDOR MANAGEMENT

(71) Applicant: Tata Consultancy Services Limited, Mumbai (IN)

(72) Inventors: Avneet SAXENA, Bangalore (IN); Sankar SARAFUL, Bangalore (IN)

(21) Appl. No.: 14/591,970

(22) Filed: Jan. 8, 2015

(30) Foreign Application Priority Data
Sep. 18, 2014 (IN) 2985/MUM/2014

(51) Int. Cl. G06Q 10/06

(52) U.S. Cl. CPC G06Q 10/06393; G06Q 10/06395

(57) ABSTRACT

The present subject matter discloses system and method for facilitating vendor management in procurement process. The method facilitates identification of one or more relevant criteria amongst plurality of criteria. The one or more relevant criteria may be identified either using random forest technique or analytical hierarchical processing (AHP). Further, method is provided for receiving optimal condition for the one or more relevant criteria, a plurality of constraints associated with each of the plurality of vendors, and a plurality of values corresponding to each of the plurality of constraints. After receiving such information, the method is further provided for processing the optimal condition, the plurality of constraints, and the plurality of values using mixed-integer linear programming (MILP) technique in order to obtain an optimal solution. The optimal solution indicates one or more vendors selected from the plurality of vendors during the procurement process.

### CROSS-REFERENCE TO RELATED APPLICATIONS AND PRIORITY

The present application claims priority under 35 U.S.C. §119 to India patent application number 2985/MUM/2014 filed on 18 Sep., 2014. The entire contents of the aforementioned application are incorporated herein by reference for all purposes.

### TECHNICAL FIELD

The present subject matter described herein, in general, relates to a method and a system for providing vendor management, more specifically, evaluating vendors in a multi-objective and multi-criteria environment.

### BACKGROUND

One of a primary objective of a procurement process is correctly identifying and selecting suitable vendors from a list of vendors capable for providing goods/services. Each of the vendors in the available list of vendors has their own limitations and advantages. Before selecting vendors from the list, an organization/enterprise has to evaluate the vendors against specific requirements of the organization. For evaluating the vendors, multiple criteria/parameters are involved corresponding to vendor's perspective. Considering the multiple criteria at once in order to evaluate the vendors becomes a challenging task. Apart from the multiple criteria, consideration of multiple objective set by the organization is also a challenge. Furthermore, selecting relevant criteria along with their weightage, from the multiple criteria, is also a challenge.

Further, the vendor evaluation practices according to current practices are generally based on strategic decisions. However, at operational level, the vendor evaluation based on these strategic decisions does not fit due to dynamic market conditions. Hence, evaluating the vendors in accordance with the dynamic market conditions becomes another challenge in the procurement process. Further, the current methodologies followed for vendor evaluation are static in nature as well as based on experience and high level thumb rules i.e., qualitative methodologies. Hence, the accuracy of results of such qualitative methodologies becomes are indefinite in nature.

### SUMMARY

This summary is provided to introduce aspects related to systems and methods for facilitating vendor management in procurement process are further described below in the detailed description. This summary is not intended to identify essential features of subject matter nor is it intended for use in determining or limiting the scope of the subject matter.

In one implementation, a system for facilitating vendor management in a procurement process is disclosed. The system comprises a processor and a memory coupled to the processor for executing a plurality of modules stored in the memory. The plurality of modules comprises an identifying module, a receiving module, and processing module. The identifying module identifies one or more relevant criteria, from a plurality of criteria, for evaluating a plurality of vendors. The identification of the one or more relevant criteria further comprises a step of computing, using a random forest technique, a Gini Score for each criterion of the plurality of criteria based on a transaction data. The transaction data indicates performance of each vendor in relative to the plurality of criteria during a predefined time interval. Further, the Gini score is normalized in order to obtain a normalized score corresponding to each criterion. Further, based on the normalized score, the identification module identifies the one or more relevant criteria from the plurality of criteria. Further, the receiving module receives an optimal condition for the one or more relevant criteria, a plurality of constraints associated with each of the plurality of vendors, and plurality of values corresponding to the one or more relevant criteria. Further, the optimal condition indicates minimizing or maximizing the one or more relevant criteria. Further, the processing module processes the optimal condition, the plurality of constraints, and the plurality of values using mixed-integer linear programming (MILP) technique in order to obtain an optimal solution. The optimal solution indicates one or more vendors selected from the plurality of vendors during the procurement process.

In another implementation, a method for facilitating vendor management in procurement process is disclosed. The method may comprise identifying, by a processor, one or more relevant criteria, from a plurality of criteria, for evaluating a plurality of vendors, Further, the identification of the one or more relevant criteria further comprises computing, using a random forest technique, a Gini Score for each criterion of the plurality of criteria based on a transaction data, wherein the transaction data indicates performance of each vendor in relative to the plurality of criteria during a predefined time interval. The method further comprises a step of normalizing the Gini score in order to obtain a normalized score corresponding to each criterion. On basis of the normalized score, the one or more relevant criteria are identified. The method further comprises, by the processor, receiving an optimal condition for the one or more relevant criteria, a plurality of constraints associated with each of the plurality of vendors, and a plurality of values corresponding to the one or more relevant criteria. Further, the optimal condition indicates minimizing or maximizing the one or more relevant criteria. The method further comprises processing, by the processor, the optimal condition, the plurality of constraints, and the plurality of values using mixed-integer linear programming (MILP) technique in order to obtain an optimal solution. The optimal solution indicates one or more vendors selected from the plurality of vendors during the procurement process.

Yet in another implementation a non-transitory computer readable medium embodying a program executable in a computing device for facilitating vendor management in a procurement process is disclosed. The program comprising a program code for identifying one or more relevant criteria, from a plurality of criteria, for evaluating a plurality of vendors. Further, the identification of the one or more relevant criteria further comprises computing, using a random forest technique, a Gini Score for each criterion of the plurality of criteria based on a transaction data, wherein the transaction data indicates performance of each vendor in relative to the plurality of criteria during a predefined time interval. Further, the Gini score is normalized in order to obtain a normalized score corresponding to each criterion. Based on the normalized score, the one or more relevant criteria are identified. The program further comprises a program code for receiving an optimal condition for the one or more relevant criteria, a plurality of constraints associated with each of the plurality of vendors, and a plurality of values corresponding to the one or more relevant criteria. The optimal condition indicates minimizing or maximizing the one or more relevant criteria. Further, the program comprises a program code for processing the optimal condition, the plurality of constraints, and the plurality of values using mixed-integer linear programming (MILP) technique in order to obtain an optimal solution, wherein the optimal solution indicates one or more vendors selected from the plurality of vendors during the procurement process.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for facilitating vendor management in a procurement process, in accordance with an embodiment of the present subject matter.

FIG. 2 illustrates the system, in accordance with an embodiment of the present subject matter.

FIG. 3A-3G illustrates an example for facilitating vendor management in detail, in accordance with an embodiment of the present subject matter.

FIG. 4 illustrates a method for facilitating vendor management in the procurement process, in accordance with an embodiment of the present subject matter.

### DETAILED DESCRIPTION

Systems and methods for facilitating vendor management in a procurement process are described. The present disclosure relates to evaluating of plurality vendors in multi-objective and multiple criteria environment. Existing methodologies followed for evaluating the plurality of vendors might lack considering multiple objectives, at a same time, set by an organization. These multiple objectives may be set on the basis of a plurality of criteria. For example, one of an objective of the organization may be to minimize cost and maximize quality and service for one or more products to be bought from a vendor. Here, the cost, quality, and service are few examples of the plurality of criteria. But, before proceeding with the evaluation of the plurality of vendors, relevant criteria may be identified from the plurality of criteria. The relevant criteria may be identified by using any one of a random forest technique or analytical hierarchical processing (AHP) technique. The random forest technique may be used when transaction data corresponding to the plurality of vendors are available. On the other hand, the AHP technique (i.e., a qualitative technique) may be used when the transaction data is not available.

For each of the plurality of criteria, a Gini score or a weightage score may be computed using the random forest technique or the AHP technique respectively. The Gini score computed may be further normalized for identifying the relevant criteria amongst the plurality of criteria. Embodiments of the present disclosure may further provide flexibility to evaluate the plurality of vendors from strategic decisions to an operational level by considering the dynamic market situation. Embodiments of the present disclosure may further provide predictive modeling for categorizing the plurality of vendors based on plurality of risk criteria for multi-objective sourcing decisions i.e., end-to-end risk optimization in the procurement process. Further, the present disclosure is not only limited to evaluating the vendors, but embodiments may also provide methodologies for developing vendor's capability by indicating right improvement area for the vendors.

Embodiments of the present disclosure may further enable user/customer for both static and dynamic vendor's selection. For static multi-criteria decision making based on random forest and AHP technique may be used, whereas the dynamic selection may be enabled by adding mathematical modeling technique. For example, a Mixed-Integer Linear Problems (MILP) based on cost minimization keeping capacity, order quantity, lead time, quality and service level constraints with integration of the random forest technique/AHP. Thus, it must be understood that the vendor selection, relevant criteria's identification, risk prioritization of the plurality of vendors, multi-objective evaluation, order identification, capacity management, and vendor development scenarios may be accomplished by various embodiments of the present disclosure.

While aspects of described system and method for facilitating vendor management in the procurement process may be implemented in any number of different computing systems, environments, and/or configurations, the embodiments are described in the context of the following exemplary system.

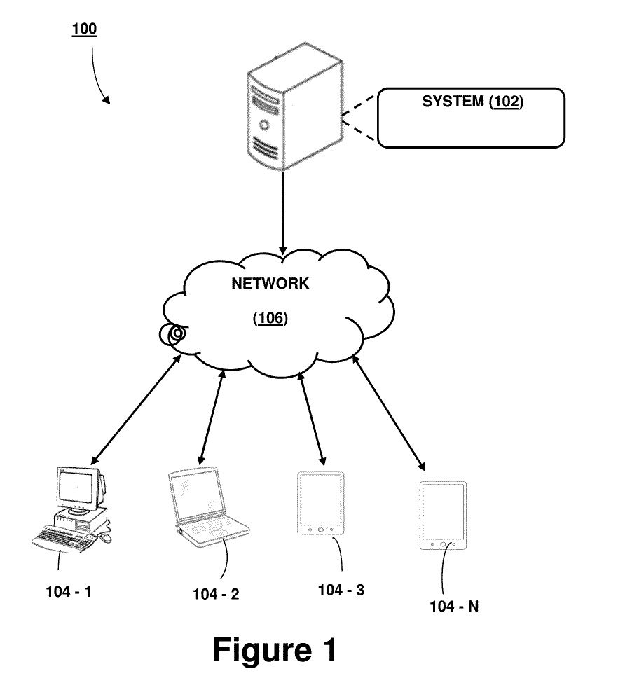

Referring to FIG. 1, a network implementation 100 of system 102 for facilitating vendor management in the procurement process is illustrated, in accordance with an embodiment of the present subject matter. Although the present subject matter is explained considering that the system 102 is implemented for facilitating the vendor management on a server, it may be understood that the system 102 may also be implemented in a variety of computing systems, such as a laptop computer, a desktop computer, a notebook, a workstation, a mainframe computer, a server, a network server, a tablet, a mobile phone, and the like. In one embodiment, the system 102 may be implemented in a cloud-based environment. It will be understood that the system 102 may be accessed by multiple users through one or more user devices 104-1, 104-2 . . . 104-N, collectively referred to as user 104 hereinafter, or applications residing on the user devices 104. Examples of the user devices 104 may include, but are not limited to, a portable computer, a personal digital assistant, a handheld device, and a workstation. The user devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

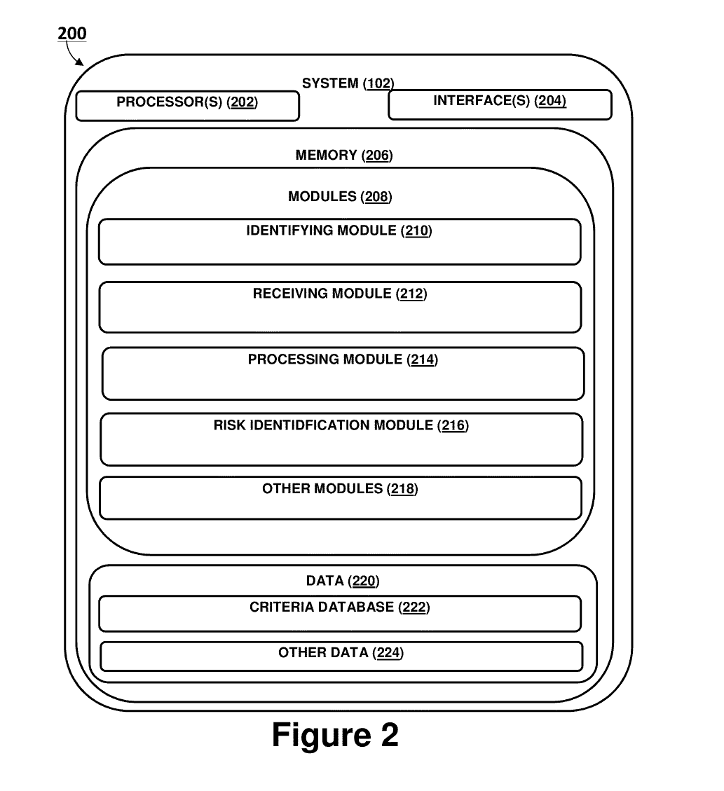

Referring now to FIG. 2, the system 102 is illustrated in accordance with an embodiment of the present subject matter. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions or modules stored in the memory 206.

The I/O interface 204 may include a variety of software and hardware interfaces, for example, a web interface, a graphical user interface, and the like. The I/O interface 204 may allow the system 102 to interact with a user directly or through the client devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium or computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, a compact disks (CDs), digital versatile disc or digital video disc (DVDs) and magnetic tapes. The memory 206 may include modules 208 and data 220.

The modules 208 may include routines, programs, objects, components, data structures, etc., which perform particular tasks or implement particular abstract data types. In one implementation, the modules 208 may include an identifying module 210, a receiving module 212, a processing module 214, risk identification module 216, and other modules 218. The other modules 218 may include programs or coded instructions that supplement applications and functions of the system 102.

The data 220, amongst other things, may serve as a repository for storing data processed, received, and generated by one or more of the modules 208. The data 220 may also include a criteria database 222, and other data 224.

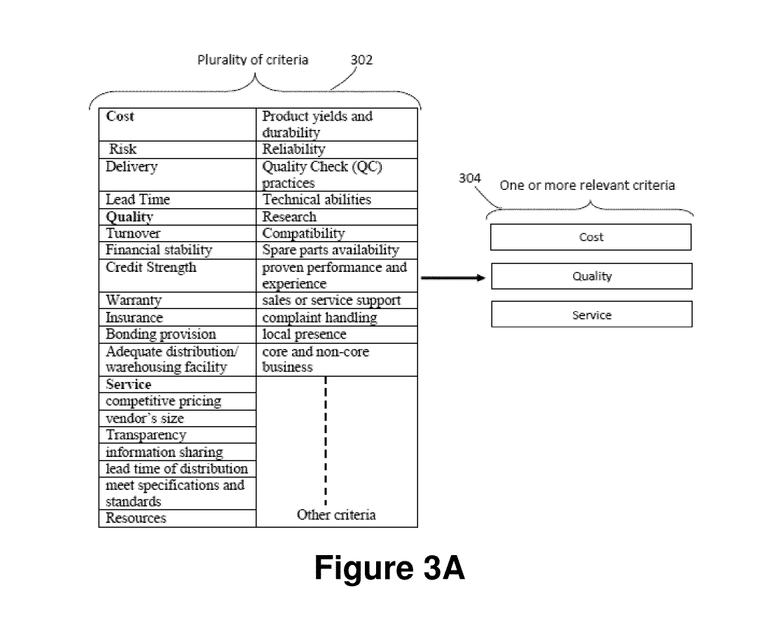

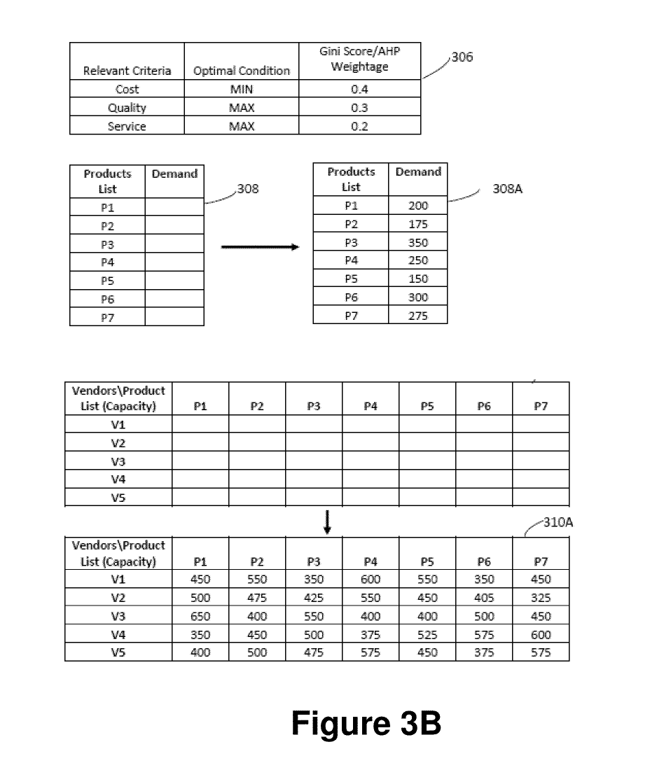

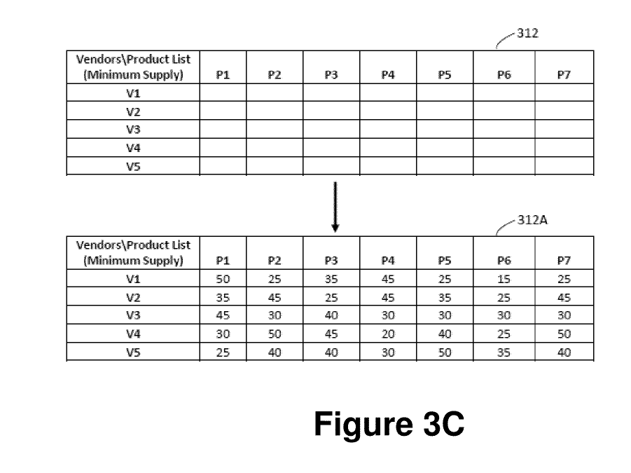

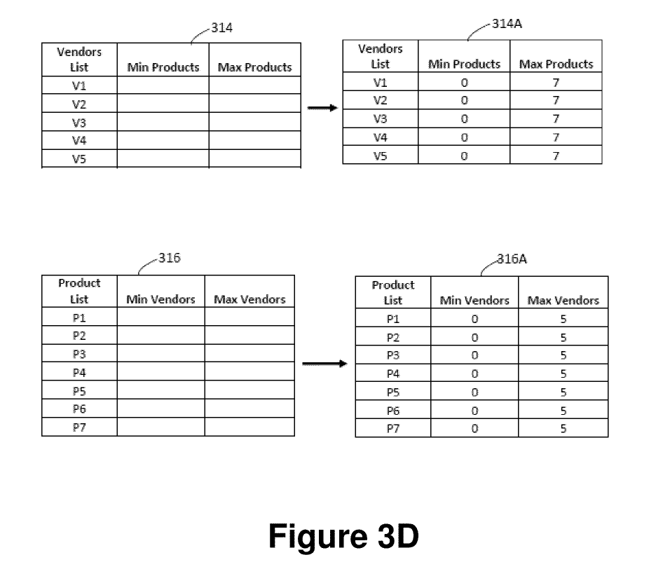

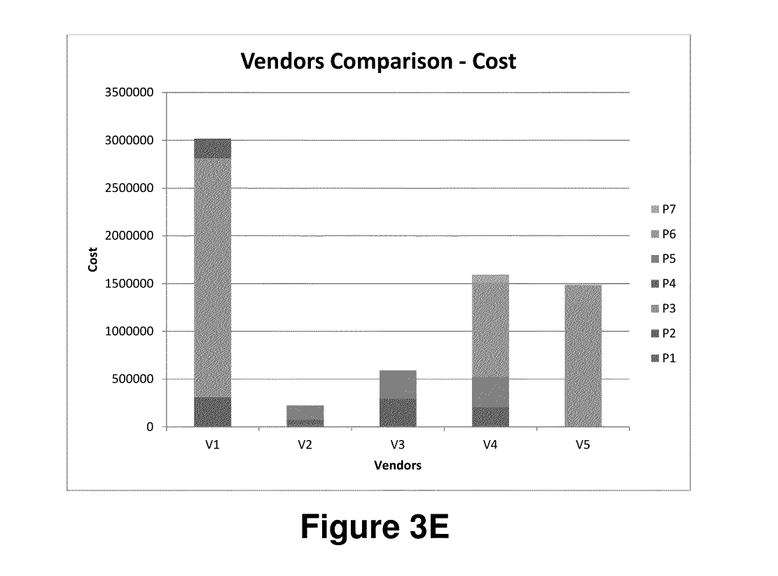

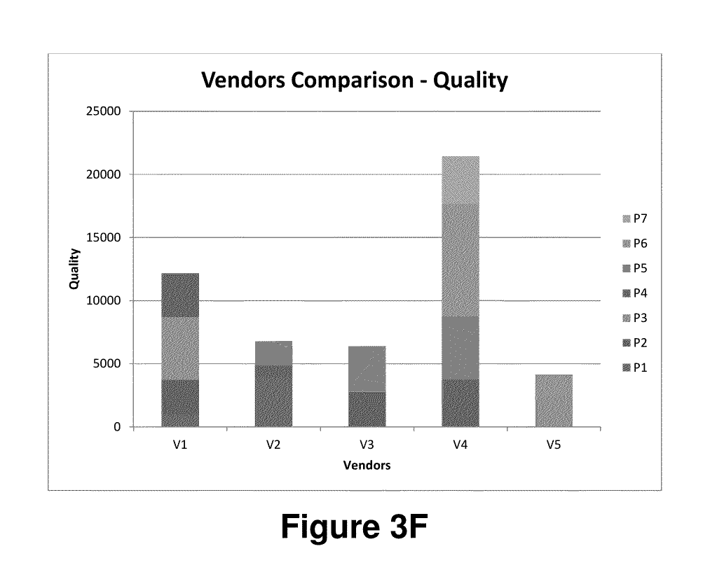

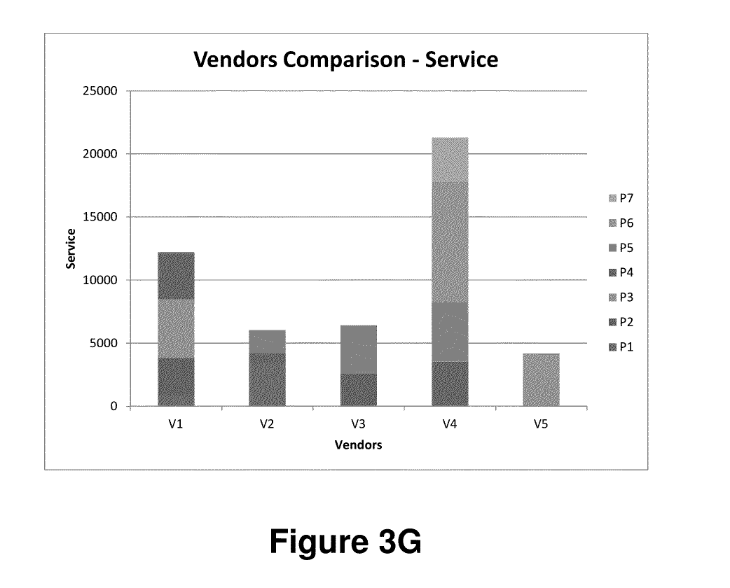

Referring now to FIG. 3A-3G, illustrates an example for facilitating vendor management in a procurement process in detail, in accordance with an embodiment of the present subject matter. In one embodiment of present disclosure, an objective of the procurement process is to evaluate plurality of vendors against a set of products. The evaluation may be performed for correctly identifying one or more vendors from the plurality of vendors. Considering an example for evaluating a set of 5 vendors (i.e., the plurality of vendors) for a set of 7 different products as shown in below tables.

Product List

Product 1
Product 2
Product 3
Product 4
Product 5
Product 6
Product 7

Plurality of vendors
V1
V2
V3
V4
V5

Thus, vendors may be selected from the list of 5 vendors that are capable of supplying the products (Product 1-Product 7) as per the objective(s) set by the requesting organization. Further, the evaluation of the plurality of vendors may also be based multiple objectives set by the organization. There may be plurality of criteria 302 available to the user. The plurality of criteria 302 may be stored in the criteria database 222 of the system 102. Amongst the plurality of criteria, one of a primary requirement is to select or identify relevant criteria as per business requirement of the organization. An identifying module 210 of the system 102 may identify one or more relevant criteria 304 from the plurality of criteria 302 in multiple steps. In first step, the identifying module 210 may compute, using a random forest technique, a Gini Score for each criterion of the plurality of criteria 302 based on a transaction data. The transaction data may indicate performance of each vendor in relative to the plurality of criteria during a predefined time interval. In one example, the transaction data for 10 different vendors may be as shown in the table below.

| Product | Vendor | Cost | Quality | Service | Reliability | Risk | Financial Health | Vendor Selected |
|---|---|---|---|---|---|---|---|---|
| P1 | V1 | 5 | 0.95 | 0.85 | 0.382 | 2 | 0.400525 | 1 |
| P1 | V2 | 4.5 | 0.98 | 0.85 | 0.100681 | 1 | 0.182623 | 1 |
| P1 | V3 | 6.5 | 0.88 | 0.85 | 0.596484 | 0 | 0.627735 | 0 |
| P1 | V4 | 5 | 0.84 | 0.85 | 0.899106 | 0 | 0.905972 | 0 |
| P1 | V5 | 4.8 | 0.75 | 0.85 | 0.88461 | 0 | 0.767174 | 1 |
| P1 | V6 | 5.19 | 0.87 | 0.99 | 0.958464 | 1 | 0.985992 | 0 |
| P1 | V7 | 5.2 | 0.95 | 0.87 | 0.014496 | 1 | 0.751976 | 1 |
| P1 | V8 | 5.5 | 0.92 | 0.87 | 0.407422 | 0 | 0.197943 | 0 |
| P1 | V9 | 5 | 0.88 | 0.88 | 0.863247 | 0 | 0.094302 | 1 |
| P1 | V10 | 5.23 | 0.78 | 0.92 | 0.138585 | 1 | 0.803308 | 0 |

From the above table, it can be seen that the transaction data may be provided for the plurality of criteria (cost, quality, service, reliability, risk, and financial health). Further, the transaction data may be considered for different time intervals like “Daily”, “Monthly”, “Quarterly”, and “Yearly”. Based on the transaction data shown in the above table, calculation of the Gini score may be performed in the following manner:

Probability of each class in the above table may be computed based on the above transaction data. Since, the probability is equal to frequency relative, the Gini Score may be computed as:

Prob(1)=5/10=0.5

Prob(0)=5/10=0.5

$$Gini Index = 1 - {\sum }_{j} {p}_{j}^{2}$$

Gini Index of table=1−(0.5̂2+0.5̂2)=0.5.

After computing the Gini score for the above table, a Gini score may be computed each criterion present in the above table. For example, the Gini score for the criteria “Risk” may be computed in the following manner:

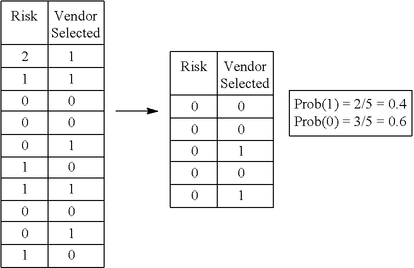

Gini Index(Risk=0)=1−(0.4̂2+0.6̂2)=0.48, similarly

Gini Index(Risk=1)=1−(0.5̂2+0.5̂2)=0.5 and

Gini Index(Risk=2)=1−(1̂2+0̂2)=0

Based on the above computation, the Gini score for the criteria “risk” may be computed as:

(Gain of table−Sum(nk/n*Gini of each value in the attribute)

i.e., =0.5−(5/10*0.48+4/10*0.5+1/10*0)=0.06

Thus, the Gini score for the criteria “risk” is computed as “0.06”. In another example, the Gini score computed for the one or more relevant criteria 304 (cost, quality, and service) can be seen at table 306 of FIG. 3B. The Gini scores computed for cost, quality, and service in that example are “0.4”, “0.3”, and “0.2” respectively. There may be plurality of criteria, associated with the vendors, for which the Gini score may be computed. The plurality of criteria may comprise cost, quality, service, delivery, priority, lead time, risk, turnover, financial stability, credit strength, warranty, insurance, bonding provisions, adequate distribution or warehousing facility, resources, competitive pricing, vendor's size, transparency, information sharing, lead time of distribution, meet specifications and standards, service quality, product yields and durability, reliability, Quality Check (QC) practices, technical abilities, research, compatibility, spare parts availability, proven performance and experience, sales or service support, complaint handling, local presence, and core and non-core business. Further, it will be understood by a person skilled in art that the one or more relevant criteria may also be identified from the plurality of criteria by using the AHP technique. The AHP technique used may compute a weightage score for each of the plurality of criteria. Further, based on the weightage score, the one or more relevant score may be identified. Further, the APH technique may be used when the transaction data is not available. According to embodiments of present disclosure, the identification of the one or more relevant criteria may be performed in a distributed environment using Hadoop®. Thus, the methodology can be used in the distributed environment to operate on big data.

After computing the Gini score for the one or more relevant criteria, a receiving module 212 of the system 102 may receive an optimal condition for the one or more criteria. The optimal condition received, in one example, may be as shown in the table 306 of FIG. 3B. Further, the optimal condition received may indicate minimizing or maximizing the one or more relevant criteria. From the table 306, it can be seen that the optimal condition received for the relevant criteria i.e., cost, quality, and service may be “MIN”, “MAX”, and “MAX” respectively. From the table 306, it can be understood that one of the objectives of the organization is to minimize the cost, and maximize the service and quality for a set of products to be bought from the plurality of vendors.

The receiving module 212 may further receive plurality of constraints associated with each of the plurality of vendors. According to embodiments of present disclosure, the plurality of constraints may comprise demand for products, capacity of the plurality of vendors for supplying the products, minimum supply of the products provided by the plurality of vendors, minimum and maximum number of the products to be supplied by each of the plurality of vendors, minimum and maximum number of vendors to be selected for supplying the products and other contractual information. After receiving the plurality of constraints, the receiving module 212 may be further enabled to receive plurality of values corresponding to the one or more relevant criteria. Further, some of the constraints are shown in tables 308 to 316 of FIG. 3B to 3D. Also, the plurality of values received for each of the plurality of constraints is shown in tables 308A to 316A.

For example, the constraint “demand of products” is shown in table 308 of FIG. 3B. Further, the values received for this constraint are shown in the table 308A of FIG. 3B. It may be observed from the table 308A that the demand for the product “P3” and “P5” is 350 and 150 respectively. Similarly, the constraint “capacity of the plurality of vendors for supplying the products” is shown in table 310 of FIG. 3B. The values associated with this constraint are shown, for this example, in table 310A of the FIG. 3B. It can be seen from the table 310A that the capacity of vendor “V2” for supplying the product “P4” is “550”. Similarly, it can be seen from the table 310A that the capacity of vendor “V5” for supplying the product “P1” is “400”. Further, another constraint i.e., “minimum supply of the products provided by the plurality of vendors” is shown in table 312 in FIG. 3C. Further, the values received for this constraint (i.e., minimum supply) may be seen from the table 312A of the FIG. 3C. Similarly, a next constraint i.e., “minimum and maximum number of the products to be supplied by each of the plurality of vendors” is shown in table 314 of FIG. 3D. Also, the values received for this constraint is shown in table 314A of the FIG. 3D. It can be seen from the table 314A that the minimum and maximum number of the products to be supplied by vendor “V3” is “0” and “7” respectively. Similarly, another constraint i.e., “minimum and maximum number of vendors to be selected for supplying the products” is shown in table 316 of the FIG. 3D. Further, the values received for this constraint is shown in table 316A of the FIG. 3D. It can be observed from the table 316A that minimum and maximum vendor to be selected for the product “P4” is “0” and “5” respectively.

After receiving the optimal condition, the plurality of constraints, and the plurality of values for each of the plurality of constraints, a processing module 214 may process these received items (optimal condition, plurality of constraints, and plurality of values) using mixed-integer linear programming (MILP) technique in order to obtain an optimal solution. Further, the optimal solution obtained may indicate one or more vendors from the plurality of vendors (V1-V5 in this case). The one or more vendors (optimal solution) may be the best combination of vendors which the system 102 can identify for the relevant criteria (cost, quality, and service).

After computing the optimal condition, the system 102 may be further configured for displaying results indicating comparison between the vendors based on the one or more relevant criteria. According to an embodiment of present disclosure, vendor comparison for the criteria “Cost” can be represented by graph/chart as shown in FIG. 3E. It can be observed that different color combinations may be used for comparing the different vendors for each product (P1-P7 in this case).

Similarly, the comparison between the vendors for the criteria “quality” can be represented by a graph/chart as shown in FIG. 3F. From the FIG. 3F, it may be observed that the vendors may be compared by using different colors for each product. Similarly, comparison between the vendors for the criteria “service” can be represented by a graph/chart as shown in FIG. 3G. In one example, from the FIG. 3F, it can be seen that the optimal solution i.e., best vendor providing maximum quality for the product “P6,” in this example, is vendor “V4”. Similarly, again the vendor “V4” is determined in this example to be the best vendor (optimal solution) for providing maximum service for the product “P6” (FIG. 3G). Thus, the comparison between the different vendors using different colors can help the user to take appropriate decisions for selecting the right vendors from the plurality of vendors based on the objective(s) of the organization.

Apart from identifying right vendors for a set of criteria, the system 102 may also be further enabled for segmenting the vendors and profiling them based on their performance. Profiling the vendors might help them in highlighting areas of improvement for the vendors. Further, the risk identification module 216 of the system 102 may be configured to determine a risk score using a logistic regression based on one or more risk criteria associated with the vendors. The one or more risk criteria may comprise financial stability, market share, service, quality, on time delivery, variables related to the vendor impacting quality, environmental and hazardous risk, operations risk, criticality of product, and catastrophic risk, wherein the catastrophic risk comprises fire, labor unrest, and flood. One objective of the risk identification module 216 may be, for example, to provide vendor's risk management by considering all the risk factors to minimize the disruption. The vendor's risk management may be for ensuring uninterrupted supply and also for minimizing security threats.

According to embodiments of present disclosure, for providing the vendor's risk management, different parameters may be considered such as hybrid multi phase approach for risk identification, risk assessment, risk prediction, and risk mitigation. It may be a two-phase approach, in which a first phase is AHP-based multi-criteria risk assessment with mathematical modeling. Further, a second phase may be based on predictive modeling (i.e. logistic regression, neural network etc) which might help in predicting the risk score. Thus, the first phase may be based on the AHP technique, heuristics and mathematical modeling to provide risk score card with minimum historical data (e.g. judgmental based pair wise comparison of criteria's). On the other hand, the second phase may be required when significant historical data will be available for predictive risk score modeling. The predictive risk score modeling may require significant historical data of supplier's information, risk factors & their weightages and various criteria like cost, order fulfillment, service level etc. These predictive techniques-based vendor assessment may enable a user to understand characteristics of vendors that lead to increased vendor's risk. This type of assessment may use history of the vendors with characteristics of the vendors and the associated risk.

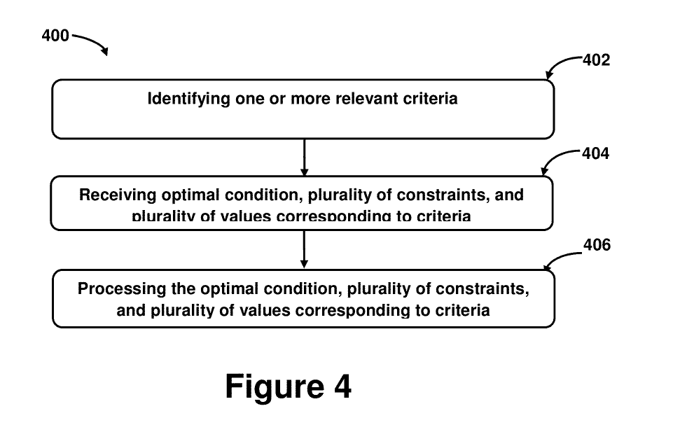

Referring now to FIG. 4, the method of facilitating vendor management in a procurement process is shown, in accordance with an embodiment of the present subject matter. The method 400 may be described in the general context of computer executable instructions. Generally, computer executable instructions can include routines, programs, objects, components, data structures, procedures, modules, functions, etc., that perform particular functions or implement particular abstract data types. The method 400 may also be practiced in a distributed computing environment where functions are performed by remote processing devices that are linked through a communications network. In a distributed computing environment, computer executable instructions may be located in both local and remote computer storage media, including memory storage devices.

The order in which the method 400 is described is not intended to be construed as a limitation, and any number of the described method blocks can be combined in any order to implement the method 400 or alternate methods. Additionally, individual blocks may be deleted from the method 400 without departing from the spirit and scope of the subject matter described herein. Furthermore, the method can be implemented in any suitable hardware, software, firmware, or combination thereof. However, for ease of explanation, in the embodiments described below, the method 400 may be considered to be implemented in the above described system 102.

At block 402, one or more relevant criteria may be identified from plurality of criteria. In one embodiment, the one or more relevant criteria may be identified by computing a Gini score for each criterion using a random forest technique based on transaction data. Further, the Gini score may be normalized for obtaining a normalized score for each criterion. Based on the normalized score, the one or more relevant criteria may be identified. Further, the random forest technique may be used when a transaction data is available, wherein the transaction data may indicate performance of each vendor in relation to the plurality of criteria during a predefined time interval. In another embodiment, the one or more relevant criteria may be identified using an analytical hierarchical processing (AHP) technique, wherein the AHP technique may provide weightage scores for each of the criteria. The AHP technique may be used when the transaction data is not available.

At block 404, an optimal condition for the one or more relevant criteria, plurality of constraints associated with each of the plurality of vendors, and plurality of values corresponding to the one or more relevant criteria may be received. The optimal condition received may indicate minimizing or maximizing the one or more relevant criteria.

At block 406, the optimal condition, the plurality of constraints, and the plurality of values are processed by using mixed-integer linear programming (MILP) technique in order to obtain an optimal solution. Further, the optimal solution indicates one or more vendors selected from the plurality of vendors during the procurement process.

Although implementations for methods and systems for facilitating vendor management have been described in language specific to structural features and/or methods, it is to be understood that the appended claims are not necessarily limited to the specific features or methods described. Rather, the specific features and methods are disclosed as examples of implementations for facilitating vendor management in the procurement process.

We claim:

1. A method for facilitating vendor management in a procurement process, the method comprising:
identifying, by a hardware processor, one or more relevant criteria, from a plurality of criteria, for evaluating a plurality of vendors, wherein the identification of the one or more relevant criteria further comprises:
computing by the hardware processor, using a random forest technique, a Gini Score for each criterion of the plurality of criteria based on a transaction data, wherein the transaction data indicates performance of each vendor in relative to the plurality of criteria during a predefined time interval,
normalizing, by the hardware processor, the Gini score in order to obtain a normalized score corresponding to each criterion, and
identifying, by the hardware processor, the one or more relevant criteria based on the normalized score;
receiving, by the hardware processor:
an optimal condition for the one or more relevant criteria, wherein the optimal condition indicates minimizing or maximizing the one or more relevant criteria,
a plurality of constraints associated with each of the plurality of vendors, and
a plurality of values corresponding to the one or more relevant criteria; and
processing, by the hardware processor, the optimal condition, the plurality of constraints, and the plurality of values using mixed-integer linear programming (MILP) technique in order to obtain an optimal solution, wherein the optimal solution indicates one or more vendors selected from the plurality of vendors during the procurement process.

2. The method of claim 1, wherein the one or more relevant criteria is also identified using an analytical hierarchical processing (AHP) technique, wherein the AHP technique provides weightage score for each of the plurality of the criteria.

3. The method of claim 1, wherein the plurality of criteria associated with the plurality of vendors comprises cost, quality, service, delivery, priority, lead time, risk, turnover, financial stability, credit strength, warranty, insurance, bonding provisions, adequate distribution or warehousing facility, resources, competitive pricing, vendor's size, transparency, information sharing, lead time of distribution, meet specifications and standards, service quality, product yields and durability, reliability, Quality Check (QC) practices, technical abilities, research, compatibility, spare parts availability, proven performance and experience, sales or service support, complaint handling, local presence, and core and non-core business.

4. The method of claim 1 further comprising:
determining a risk score using a logistic regression based on one or more risk criteria associated with the vendors, wherein the one or more risk criteria comprises financial stability, market share, service, quality, on time delivery, variables related to the vendor impacting quality, environmental and hazardous risk, operations risk, criticality of product, and catastrophic risk, wherein the catastrophic risk comprises fire, labor unrest, and flood.

5. The method of claim 1, wherein the plurality of constraints comprises demand of products, capacity of the plurality of vendors for supplying the products, minimum supply of the products provided by the plurality of vendors, minimum and maximum number of the products to be supplied by each of the plurality of vendors, minimum and maximum number of vendors to be selected for supplying the products and other contractual information.

6. A system 102 for facilitating vendor management in a procurement process, wherein the system comprises:
a hardware processor;
a memory coupled to the hardware processor, wherein the hardware processor is capable of executing instructions stored in the memory for:
identifying, via the hardware processor, one or more relevant criteria, from a plurality of criteria, for evaluating a plurality of vendors, wherein the identification of the one or more relevant criteria further comprises:
computing, using a random forest technique, a Gini Score for each criterion of the plurality of criteria based on a transaction data, wherein the transaction data indicates performance of each vendor in relative to the plurality of criteria during a predefined time interval,
normalizing the Gini score in order to obtain a normalized score corresponding to each criterion, and
identifying the one or more relevant criteria based on the normalized score;
receiving, via the hardware processor,
an optimal condition for the one or more relevant criteria, wherein the optimal condition indicates minimizing or maximizing the one or more relevant criteria,
a plurality of constraints associated with each of the plurality of vendors, and
plurality of values corresponding to the one or more relevant criteria; and
processing, via the hardware processor, the optimal condition, the plurality of constraints, and the plurality of values using mixed-integer linear programming (MILP) technique in order to obtain an optimal solution, wherein the optimal solution indicates one or more vendors selected from the plurality of vendors during the procurement process.

7. The system of claim 6, wherein the one or more relevant criteria is also identified using an analytical hierarchical processing (AHP) technique, wherein the AHP technique provides weightage score for each of the plurality of the criteria.

8. The system of claim 6, wherein the plurality of criteria associated with the plurality of vendors comprises cost, quality, service, delivery, priority, lead time, risk, turnover, financial stability, credit strength, warranty, insurance, bonding provisions, adequate distribution or warehousing facility, resources, competitive pricing, vendor's size, transparency, information sharing, lead time of distribution, meet specifications and standards, service quality, product yields and durability, reliability, Quality Check (QC) practices, technical abilities, research, compatibility, spare parts availability, proven performance and experience, sales or service support, complaint handling, local presence, and core and non-core business.

9. The system of claim 6, wherein the hardware processor is further capable of executing instructions stored in the memory for:
determining a risk score using a logistic regression based on one or more risk criteria associated with the vendors, wherein the one or more risk criteria comprises financial stability, market share, service, quality, on time delivery, variables related to the vendor impacting quality, environmental and hazardous risk, operations risk, criticality of product, and catastrophic risk, wherein the catastrophic risk comprises fire, labor unrest, and flood.

10. A non-transitory computer readable medium embodying a program executable by a hardware processor for facilitating vendor management in a procurement process, the program comprising program code for:
identifying one or more relevant criteria, from a plurality of criteria, for evaluating a plurality of vendors, wherein the identification of the one or more relevant criteria further comprises:
computing, using a random forest technique, a Gini Score for each criterion of the plurality of criteria based on a transaction data, wherein the transaction data indicates performance of each vendor in relative to the plurality of criteria during a predefined time interval,
normalizing the Gini score in order to obtain a normalized score corresponding to each criterion, and
identifying the one or more relevant criteria based on the normalized score;
a program code for receiving
an optimal condition for the one or more relevant criteria, wherein the optimal condition indicates minimizing or maximizing the one or more relevant criteria,
a plurality of constraints associated with each of the plurality of vendors, and
a plurality of values corresponding to the one or more relevant criteria; and
processing the optimal condition, the plurality of constraints, and the plurality of values using mixed-integer linear programming (MILP) technique in order to obtain an optimal solution, wherein the optimal solution indicates one or more vendors selected from the plurality of vendors during the procurement process.
